(19) United States
(12) Patent Application Publication
(10) Pub. No.: US 2013/0272456 A1
(43) Pub. Date: Oct. 17, 2013

(54) DECODING APPARATUS AND DECODING METHOD FOR DECODING DATA ENCODED BY LDPC

(71) Applicant: JVC Kenwood Corporation, Yokohama-shi (JP)

(72) Inventors: Atsushi HAYAMI, Yokohama-shi (JP); Masafumi IWASA, Yokohama-shi (JP)

(21) Appl. No.: 13/830,290

(22) Filed: Mar. 14, 2013

Related U.S. Application Data
(63) Continuation of application No. PCT/JP2011/005289, filed on Sep. 20, 2011.

(30) Foreign Application Priority Data
Sep. 30, 2010 (JP) 2010-222977

(51) Int. Cl. H04L 25/02

(52) U.S. Cl. CPC H04L 25/02
USPC 375/340

(57) ABSTRACT

A frame data storage unit inputs LDPC encoded data via a communication path. An estimation unit estimates, based on the inputted data, a situation of the communication path. A selection unit select, in accordance with the estimated situation of the communication path, one of a plurality of normalization constants that have been specified in advance and are to be used in updating an exterior value ratio based on a priori value ratio in check node processing according to a min-sum algorithm. A min-sum processing unit executes, on the inputted data, the min-sum algorithm by using the selected normalization constant.

### BACKGROUND OF THE INVENTION

1. Field of the Invention

The present invention relates to a decoding technique, and more particularly to a decoding apparatus and a decoding method for decoding data encoded by LDPC.

2. Description of the Related Art

In recent years, LDPC (Low Density Parity Check Code) attracts attention as an error correction code having high error correction performance even in a transmission path with a low S/N, and the LDPC is applied in many fields. In the LDPC, data is encoded with an encoding matrix generated based on s sparse check matrix on a transmission side. Herein, the sparse check matrix is a matrix in which elements are either 1 or 0 and the number of 1s is small. On the other hand, data is decoded and parity check is performed based on the check matrix on a receiving side. In particular, the decoding performance is improved by iterative decoding according to BP (Belief Propagation) method, etc.

In this decoding, check node processing for decoding in a row direction of the check matrix and variable node processing for decoding in a column direction are repeatedly executed. Sum-product decoding using Gallager or hyperbolic functions is known as one of the check node processing. In the sum-product decoding, a communication path value obtained from a distribution value of transmission path noise is used as a priori value. In addition, in the case of wireless communication, a received amplitude variation occurs due to fading, etc. In order to derive a communication path value under such a situation, a channel estimation value is derived based on a hard decision value of a decoding result and a received signal.

When a channel estimation value is estimated based on a hard decision value of a decoding result and a received signal, a square operation is required for every received data symbol, and hence an amount of computation is increased. If an amount of computation for estimating a communication path value is large, a processing time becomes long and power consumption also becomes large. If a processing time becomes long, it becomes impossible to follow a received amplitude variation by fading, thereby causing reception quality to be deteriorated. Accordingly, it is preferable that an amount of computation for deriving a communication path value is small.

A simplified decoding method of the sum-product decoding is min-sum decoding. In the min-sum decoding, check node processing can be performed by performing simple processing, such as comparison operation and summation operation, without using complicated functions. Further, because the min-sum decoding does not require a communication path value, it is widely used for simplifying the processing and increasing the speed thereof. On the other hand, when fading occurs, the decoding characteristic of the min-sum decoding tends to be more deteriorated than that of the sum-product decoding in which an appropriate communication path value has been reflected.

### SUMMARY OF THE INVENTION

The present invention has been made in view of these situations, and a purpose of the invention is to provide a technique in which deterioration of the decoding characteristic can be suppressed even when the min-sum decoding is used under an environment in which a situation of a communication path becomes bad.

In order to solve the aforementioned problem, a decoding apparatus according to an aspect of the present invention comprises: an input unit configured to input encoded data via a communication path; an estimation unit configured to estimate a situation of the communication path based on the data inputted by the input unit; a selection unit configured to select, in accordance with the situation of the communication path estimated by the estimation unit, one of a plurality of normalization constants that have been specified in advance and are to be used in updating an exterior value ratio based on a priori value ratio in check node processing according to a min-sum algorithm; and a decoding unit configured to execute, on the data inputted by the input unit, the min-sum algorithm by using the normalization constant selected by the selection unit.

According to this aspect, one of a plurality of normalization constants that have been specified in advance is selected in accordance with the estimated situation of the communication path, for the execution of a min-sum algorithm, and hence a normalization constant suitable for the communication path can be used.

The selection unit may select a normalization constant having a smaller value, as the situation of the communication path estimated by the estimation unit becomes worse. In this case, because a normalization constant having a smaller value is selected as the situation of the communication path becomes worse, an influence possibly exerted on the update of an external value ratio can be reduced.

The estimation unit may estimate a degree of a fading variation as the situation of the communication path, and the selection unit may select a normalization constant having a smaller value, as the degree of a fading variation estimated by the estimation unit becomes quicker. In this case, because a normalization constant having a smaller value is selected as a degree of a fading variation becomes quicker, an influence possibly exerted on the update of an external value ratio can be reduced.

The estimation unit may estimate, as the situation of the communication path, a period during which an amplitude variation occurs, and the selection unit may select a normalization constant having a smaller value, as the period during which an amplitude variation occurs, estimated by the estimation unit, becomes longer. In this case, because a normalization constant having a smaller value is selected as a period during which an amplitude variation occurs becomes longer, an influence possibly exerted on the update of an external value ratio can be reduced.

Another aspect of the present invention is a decoding method. This method comprises: inputting encoded data via a communication path; estimating, based on the inputted data, a situation of the communication path; selecting, in accordance with the estimated situation of the communication path, one of a plurality of normalization constants that have been specified in advance and are to be used in updating an external value ratio based on a priori value ratio in check node processing according to a min-sum algorithm; and executing, on the inputted data, the min-sum algorithm by using the selected normalization constant.

In the above selection, a normalization constant having a smaller value may be selected as the estimated situation of the communication path becomes worse.

In the above estimation, a degree of a fading variation may be estimated as the situation of the communication path, and in the above selection, a normalization constant having a smaller value may be selected as the estimated degree of a fading variation becomes quicker.

In the above estimation, a period during which an amplitude variation occurs may be estimated as the situation of the communication path, and in the above selection, a normalization constant having a smaller value may be selected as the estimated period during which an amplitude variation occurs becomes longer.

It is noted that any combination of the aforementioned components or any manifestation of the present invention realized by modifications of a method, apparatus, system, storing media, computer program, and so forth, is effective as an aspect of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a view illustrating the structure of a communication system according to First Embodiment of the present invention;

FIG. 2 is a view illustrating a check matrix to be used in an LDPC encoding unit and a decoding unit in FIG. 1;

FIG. 3 is a view illustrating the structure of the decoding unit in FIG. 1;

FIGS. 4A to 4H are views explaining the outline of the operations of the decoding unit in FIG. 3;

FIG. 5 is a view illustrating a Tanner graph schematically indicating the operations of the decoding unit in FIG. 3;

FIG. 6 is a view illustrating the outline of an external value ratio in the decoding unit in FIG. 3;

FIG. 7 is a view illustrating the outline of a priori value ratio in the decoding unit in FIG. 3;

FIG. 8 is a graph showing a BER characteristic of a reception apparatus in FIG. 1 in a static state;

FIG. 9 is a graph showing a BER characteristic of the reception apparatus in FIG. 1 in a fading state;

FIG. 10 is a flowchart indicating decoding procedures in the decoding unit in FIG. 3;

FIG. 11 is a flowchart indicating decoding procedures in a decoding unit according to Second Embodiment of the present invention;

FIGS. 12A to 12H are views explaining the outline of the operations of a decoding unit according to Third Embodiment of the present invention;

FIG. 13 is a flowchart indicating decoding procedures in the decoding unit according to Third Embodiment of the present invention; and

FIG. 14 is a flowchart indicating decoding procedures in a decoding unit according to Fourth Embodiment of the present invention.

### DETAILED DESCRIPTION OF THE INVENTION

The invention will now be described by reference to the preferred embodiments. This does not intend to limit the scope of the present invention, but to exemplify the invention.

### First Embodiment

Before the present invention is described specifically, the outline thereof will be first stated. First Embodiment of the invention relates to a communication system including a transmission apparatus for executing LDPC encoding and a reception apparatus for executing, on the data encoded in the transmission apparatus (hereinafter, referred to as “encoded data”), iterated decoding based on a check matrix. In particular, the reception apparatus executes a min-sum algorithm. As stated above, the min-sum algorithm does not require a communication path value, but when fading occurs, the decoding characteristic thereof is likely to be more deteriorated than that of a sum-product algorithm in which a suitable communication path value has been reflected. In order to deal with this, the communication system according to the present embodiment, in particular, the reception apparatus is structured as follows.

The reception apparatus estimates a situation of a communication path based on a received signal. Herein, in order to simplify the processing, it is estimated as the situation of the communication path whether a situation in which fading with a rather high Doppler frequency occurs (hereinafter, referred to as a “fading occurring situation”) occurs or a situation in which fading with a rather high Doppler frequency does not occur (hereinafter, referred to as a “usual situation”) occurs. On the other hand, the reception apparatus stores, in a memory, two types of normalization constants to be used in the min-sum algorithm as parameters, normalization constants. One of them is a normalization constant to be used in the usual situation (hereinafter, referred to as a “usual normalization constant”), and the other is a normalization constant to be used in the fading occurring situation (hereinafter, referred to as a “normalization constant for fading”). When estimating that a normal situation occurs, the reception apparatus extracts a usual normalization constant from the memory to execute a min-sum algorithm by using the usual normalization constant. On the other hand, when estimating that fading occurs, the reception apparatus extracts a normalization constant for fading from the memory to execute a min-sum algorithm by using the normalization constant for fading.

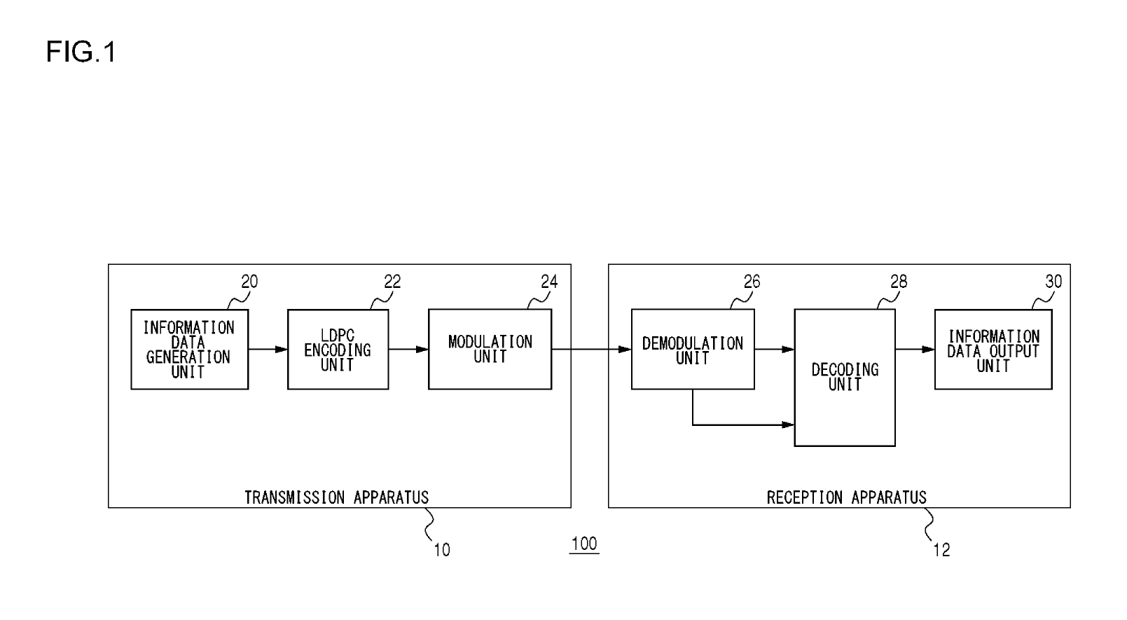

FIG. 1 is a view illustrating the structure of a communication system 100 according to First Embodiment of the present invention. The communication system 100 includes the transmission apparatus 10 and the reception apparatus 12. The transmission apparatus 10 includes an information data generation unit 20, an LDPC encoding unit 22, and a modulation unit 24. The reception apparatus 12 includes a demodulation unit 26, a decoding unit 28, and an information data output unit 30.

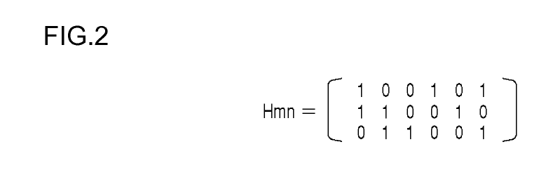

The information data generation unit 20 acquires data to be transmitted and generates information data. Alternatively, the acquired data may be used as the information data as it is. The information data generation unit 20 outputs the information data to the LDPC encoding unit 22. The LDPC encoding unit 22 receives the information data from the information data generation unit 20. The LDPC encoding unit 22 attaches a parity based on a check matrix by the LDPC (hereinafter, referred to as an “LDPC parity”) to the information data. The information data to which the LDPC parity has been attached is equivalent to the aforementioned encoded data. The LDPC encoding unit 22 outputs the encoded data to the modulation unit 24. FIG. 2 illustrates a check matrix to be used in the LDPC encoding unit 22. The check matrix Hmn is a matrix having m rows and n columns. Herein, in order to make the description clear, the check matrix Hmn is made to have 3 rows and 6 columns, but the check matrix is not limited thereto. Reference is made to FIG. 1 again.

The modulation unit 24 receives the encoded data from the LDPC encoding unit 22. The modulation unit 24 modulates the encoded data. As modulation methods, PSK (Phase Shift Keying), FSK (Frequency Shift Keying), etc., are used. The modulation unit 24 transmits modulated encoded data as a modulated signal.

The demodulation unit 26 receives the modulated signal from the modulation unit 24 via, for example, a wireless transmission path. The demodulation unit 26 demodulates the modulated signal. A known technique may be used for the demodulation, and hence description thereof will be omitted. The demodulation unit 26 outputs a demodulation result (hereinafter, referred to as “demodulated data”) to the decoding unit 28. In addition, the demodulation unit 26 includes an AGC (Automatic Gain Control) in order to control the amplitude of the demodulated data so as to approach a constant value. The demodulation unit 26 also outputs an AGC control voltage to the decoding unit 28. Herein, there is the tendency that, when the amplitude of the received modulated signal becomes small, the AGC control voltage becomes large, and when the amplitude thereof becomes large, the AGC control voltage becomes small.

The decoding unit 28 receives the demodulated data from the demodulation unit 26 and also receives the AGC control voltage therefrom. The decoding unit 28 repeatedly executes, on the demodulated data, the decoding processing with the check matrix by the LDPC. For example, a min-sum algorithm is executed as the decoding processing. The min-sum algorithm is executed in the following procedures.

1. Initialization: a priori value ratio is initialized and the maximum number of repetitions of decoding is set.

2. Check node processing: an external value ratio is updated in the row direction of the check matrix.

3. Variable node processing: the priori value ratio is updated in the column direction of the check matrix.

4. A temporary estimated word is calculated.

Detailed description of these procedures will be omitted; however, a normalization constant is used in the later-described check node processing. The decoding unit 28 determines a normalization constant based on the AGC control voltage, but detailed description will be described later. The decoding unit 28 outputs a decoding result (hereinafter, referred to as “decoded data”) to the information data output unit 30. The information data output unit 30 receives the decoded data from the decoding unit 28. The information data output unit 30 generates information data based on the decoded data. Alternatively, the decoded data may be used as the information data as it is. The information data output unit 30 may include an outer code decoding unit such that an outer code, such as, for example, CRC, is decoded.

This structure is implemented in hardware by any CPU of a computer, memory, and other LSI, and implemented in software by a computer program or the like that is loaded in a memory. Herein, functional blocks implemented by the cooperation of hardware and software are depicted. Accordingly, it can be understood by those skilled in the art that these functional blocks may be implemented in a variety of manners by hardware only, software only, or any combination thereof.

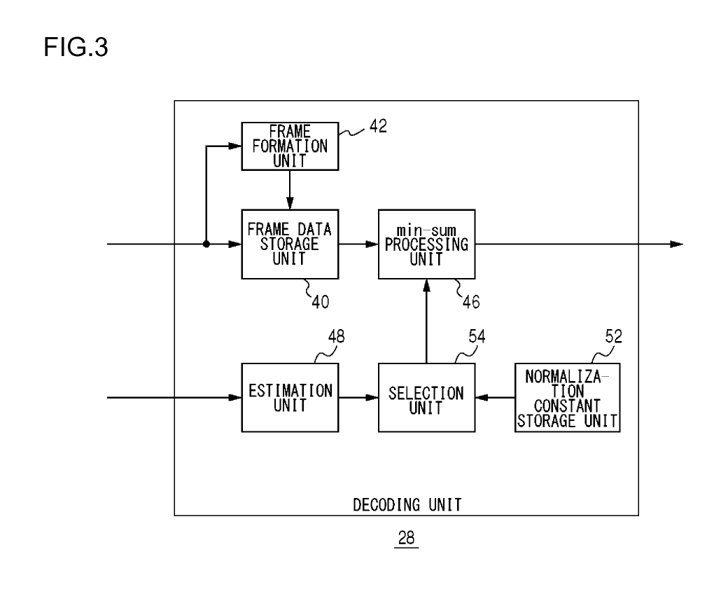

FIG. 3 illustrates the structure of the decoding unit 28. The decoding unit 28 includes a frame data storage unit 40, a frame formation unit 42, a min-sum processing unit 46, an estimation unit 48, a normalization constant storage unit 52, and a selection unit 54.

The frame formation unit 42 receives the demodulated data from the non-illustrated demodulation unit 26. It can be said that the demodulated data is LDPC encoded data via the communication path. The frame formation unit 42 detects a frame synchronization signal included in the demodulated data. The frame formation unit 42 identifies, based on the frame synchronization signal, a unit of a frame formed by the demodulated data. For example, when the frame synchronization signal is arranged at the head portion of a frame, and when the period of the frame is a fixed length, the frame formation unit 42 detects the frame synchronization signal and identifies a period of the fixed length as a frame. The frame formation unit 42 directs the frame data storage unit 40 to store the modulated signal in units of frames. The frame data storage unit 40 receives the demodulated data, similarly to the frame formation unit 42. In response to the direction from the frame formation unit 42, the frame data storage unit 40 stores the modulated signal in units of frames.

The estimation unit 48 receives the AGC control voltage from the non-illustrated demodulation unit 26. When the AGC control voltage becomes larger than a threshold value, the estimation unit 48 estimates that fading occurs. Further, the estimation unit 48 estimates, by monitoring a frequency at which fading occurs, whether fading with a Doppler frequency higher than a predetermined frequency occurs. That is, the estimation unit 48 estimates a situation of the communication path based on the received data.

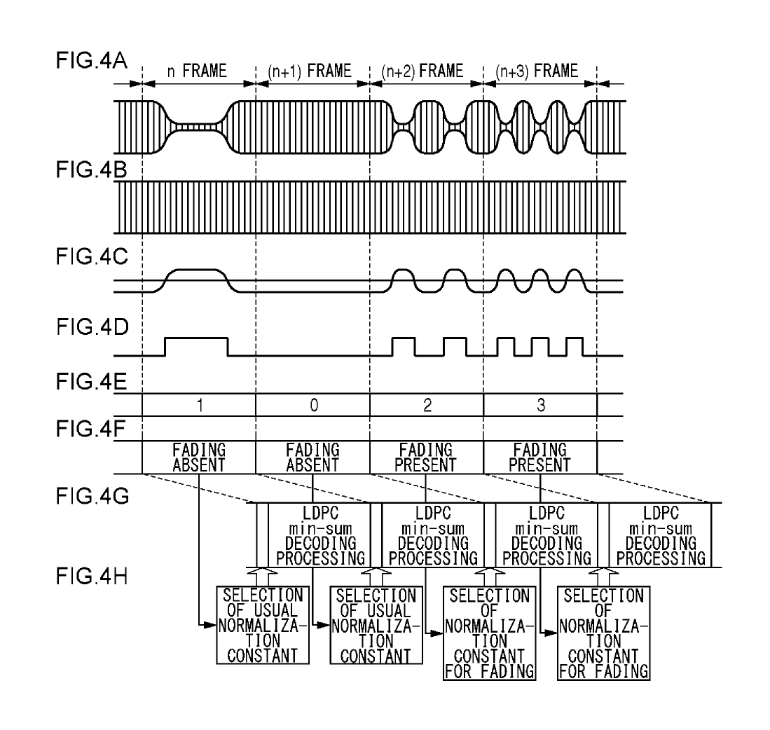

Herein, the processing in the estimation unit 48 will be described with reference to FIGS. 4A to 4H. FIGS. 4A to 4H are views explaining the outline of the operations of the decoding unit 28. The horizontal axis in each of the views represents time. FIG. 4A shows the modulated signal received by the demodulation unit 26 in FIG. 1. Herein, an n frame to an (n+3) frame are shown. As shown, the amplitude in an (n+1) frame is almost constant, but the amplitude in each of the n frame, (n+2) frame, and (n+3) frame varies. FIG. 4B shows the demodulated signal outputted from the demodulation unit 26 in FIG. 1. Because the demodulation unit 26 is provided with the AGC, as stated above, the amplitude of the demodulated signal is almost constant in all of the frames.

FIG. 4C shows the AGC control voltage outputted from the demodulation unit 26 in FIG. 1. Corresponding to the portions where the amplitude varies in FIG. 4A, the AGC control voltage becomes large in the n frame, (n+2) frame, and (n+3) frame in FIG. 4C. The estimation unit 48 compares the AGC control voltage with a threshold value, and when the AGC control voltage is larger than the threshold value, it determines that a fading movement occurs. This threshold value is set, for example, to a value obtained by adding 6 dB to the AGC control voltage in a situation where an influence by fading is small, that is, in a usual situation. FIG. 4D shows estimation results with respect to occurrence of fading. When it is estimated that fading occurs, the estimation result is set to a High level, and when it is not estimated that fading occurs, the estimation result is set to a Low level.

The estimation unit 48 counts the number of times when the estimation result in FIG. 4D changes from the Low level to the High level. This represents the number of times when a state where fading does not occur changes to a state where fading occurs, and as the number of times becomes larger, a Doppler frequency becomes higher. Thus, by counting the number of times when fading occurs in units of frames, the Doppler frequency in fading can be estimated as follows:

Doppler frequency=Counted value×Frame frequency (1)

The estimation unit 48 stores the threshold value in advance, and when the counted number of times is larger than the threshold value, the estimation unit 48 determines that “fading is present”; while when the counted number of times is smaller than the threshold value, determines that “fading is absent”. FIG. 4E shows the number of times counted for each frame by the estimation unit 48. FIG. 4F shows results of comparing the numbers of times shown in FIG. 4E and the threshold value. Herein, the threshold value is set to “2”. Reference is made to FIG. 3 again. The estimation unit 48 outputs a determination result to the selection unit 54.

The normalization constant storage unit 52 stores a plurality of normalization constants in advance. Herein, two normalization constants are stored, one of which is a usual normalization constant (hereinafter, also referred to as a “usual constant”) and the other of which is a normalization constant for fading (hereinafter, also referred to as a “constant for fading”). As stated above, the usual constant is a normalization constant to be used in a normal situation and the constant for fading is a normalization constant to be used in a situation in which fading with a Doppler frequency higher than a predetermined frequency occurs. It is assumed that the usual constant is “0.7” and the constant for fading is “0.62”. The constant for fading is a value smaller than that of the usual constant. Accordingly, as a fading frequency becomes higher, i.e., as the situation of the communication path becomes worse, the normalization constant becomes smaller.

In response to the determination results from the estimation unit 48, the selection unit 54 selects one of a plurality of normalization constants that have been stored in the normalization constant storage unit 52, and outputs the selected normalization constant to the min-sum processing unit 46. That is, the selection unit 54 selects, in accordance with the situation of the communication path estimated by the estimation unit 48, one of the plurality of normalization constants that have been specified in advance. Detailed description will be made later, but the normalization constant is a value to be used in updating, based on a priori value, an external value ratio in the check node processing according to the min-sum algorithm. The processing by the selection unit 54 will be specifically described as follows: when the determination result indicates that fading is present, the selection unit 54 selects a constant for fading from the normalization constant storage unit 52. On the other hand, when the determination result indicates that fading is absent, the selection unit 54 selects a normal constant from the normalization constant storage unit 52. Such selection is made in units of frames.

The min-sum processing unit 46 receives the demodulated data from the frame data storage unit 40 and receives the normalization constant from the selection unit 54. The min-sum processing unit 46 uses the normalization constant to execute the min-sum algorithm on the demodulated data. In FIG. 4G, the min-sum decoding processing is executed on each frame. A normalization constant to be used in this min-sum decoding processing is illustrated in FIG. 4H. When it is detected that fading is absent, a usual constant is used, while when it is detected that fading is present, a constant for fading is used. Reference is made to FIG. 3 again.

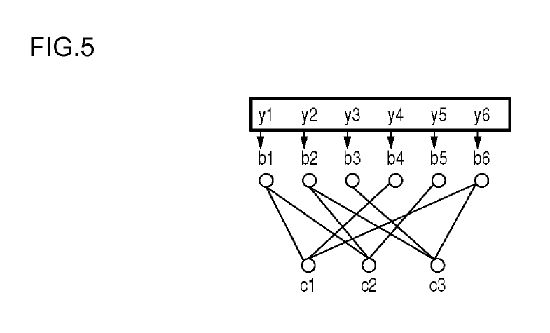

Herein, the min-sum algorithm will be described. FIG. 5 illustrates a Tanner graph schematically indicating the operations of the decoding unit 28. In the Tanner graph, b1 to b6 are referred to as variable nodes and c1 to c3 are referred to as check nodes. Herein, the number of the variable nodes is made to be n, and bn is made to be an n-th variable node. Also, the number of the check nodes is made to be m, and cm is made to be an m-th check node. Data y1 to y6 stored in the frame data storage unit 40 in FIG. 3 are linked to the variable nodes b1 to b6, respectively.

In the check node processing, an external value ratio αmn from cm to bm is updated with a variable node linked to a check node. For every group (m, n) satisfying check matrix Hmn=1, αmn is calculated as follows:

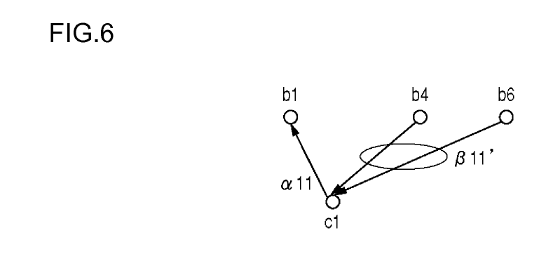

αmn=a(Πsign(βnm′))*min|βmn′| (2)

Wherein, n′ represents A(m)¥n, in which A(m) is a set of variable nodes linked to the check node m and ¥n represents a difference set not including n; sign represents a signature function; min|βnm′| represents the lowest absolute value selection; and a represents a normalization constant. FIG. 6 illustrates the outline of an external value ratio in the decoding unit 28. The external value ratio α11 is derived from β11′. Reference is made to FIG. 3 again.

In the variable node processing, a priori value ratio βmn from bn to cm is updated, based on αmn, with a check node linked to a variable node. For every group (m, n) satisfying check matrix Hmn=1, βmn is calculated as follows:

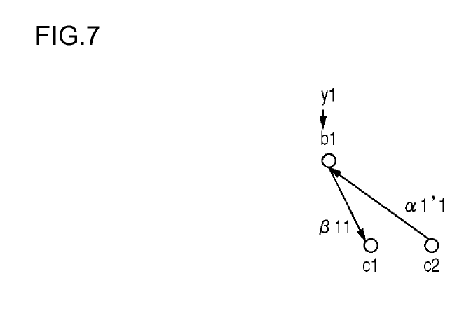

βmn=Σαm′n+λn (3)

Wherein, λn is equal to input data yn. The input data yn corresponds to the demodulated data from the demodulation unit 26. m′ represents B (n) ¥m, in which B (n) is a set of check nodes lined to the variable node n and ¥m represents a difference set not including m. FIG. 7 illustrates the outline of a priori value ratio in the decoding unit 28. The priori value ratio βii is derived from α1′1. Reference is made to FIG. 3 again. As stated above, after repeating the check node processing and the variable node processing predetermined times, the min-sum processing unit 46 calculates a temporary estimated word and ends the processing.

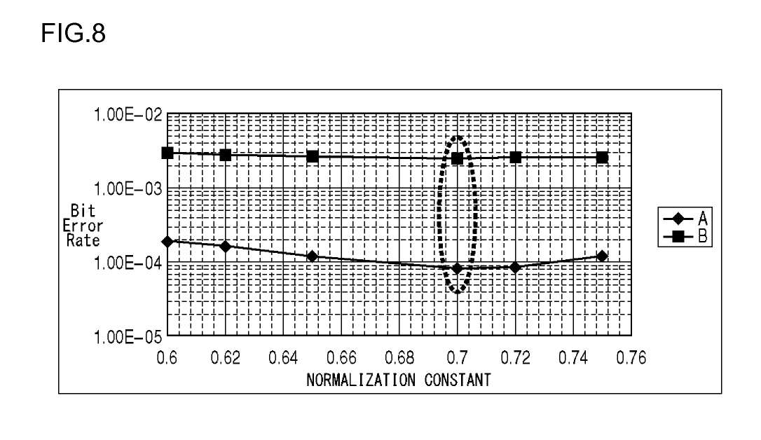

FIG. 8 is a graph showing a BER characteristic of the reception apparatus 12 in a static state. This shows a bit error rate occurring when Gaussian noise is changed under a situation in which fading does not occur. In the view, each of A and B represents a state in which a magnitude of the Gaussian noise to be added is changed, i.e., a state in which the transmission path S/N is changed. As shown, bit errors are improved when a normalization constant is approximately 0.7 (at the points enclosed by the dashed line in the view) under a static environment, independently of the transmission path S/N.

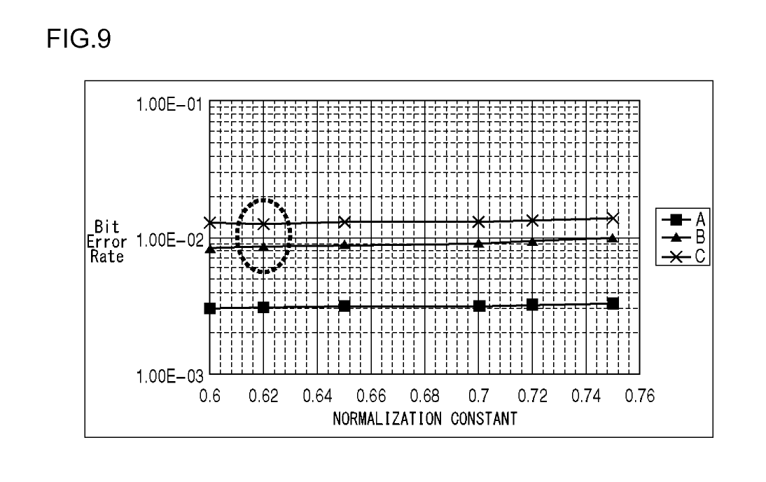

FIG. 9 is a graph showing a BER characteristic of the reception apparatus 12 in a fading state. This shows changes in a bit error, occurring when fading occurs and further a Doppler frequency is changed. In the view, A corresponds to the case where fading with a Doppler frequency lower than the frame frequency occurs, while B and C correspond to the case where fading with a Doppler frequency higher than the frame frequency occurs. As shown, when a fading frequency is lower than the frame frequency, a change in the bit error, occurring depending on a normalization constant, is small; and when fading with a frequency higher than the frame frequency occurs, the bit error can be improved by changing a normalization constant. In the present embodiment, it is preferable to set a normalization constant to approximately 0.62, as enclosed by the dashed line.

Thus, when fading with a Doppler frequency higher than the frame frequency occurs, it is preferable to set a normalization constant to a value smaller than a value that is set in the case where fading is absent or the case where fading with a Doppler frequency lower than the frame frequency occurs. As clear also from the equations (2) and (3), the normalization constant a is a constant indicating how much the demodulated data influences an external value ratio. When the S/N of a signal is greatly changed within a frame that is a decoding unit, it can be said that a decoding performance is improved by suppressing an influence possibly exerted on an external value.

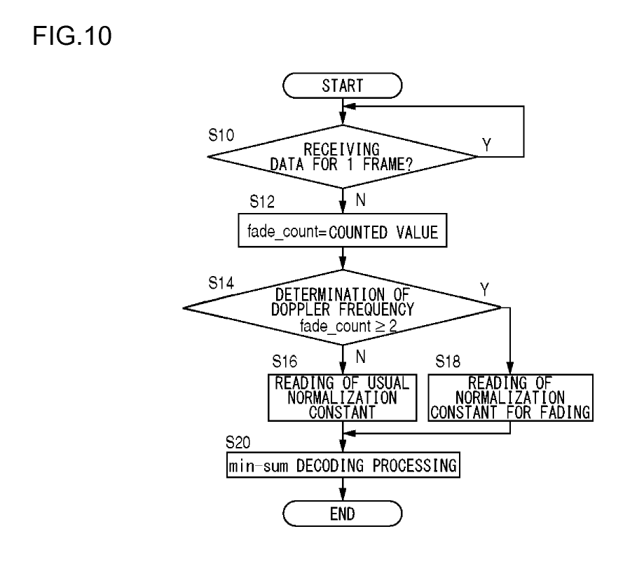

The operations of the communication system 100 having the aforementioned structure will be described. FIG. 10 is a flowchart indicating decoding procedures in the decoding unit 28. When the frame data storage unit 40 is receiving data for one frame (S10/Y), the estimation unit 48 waits. When the frame data storage unit 40 is not receiving data for one frame (S10/N), the estimation unit 48 inputs a counted value to a fade_count (S12). When fade_count≧2 is not satisfied in Doppler frequency determination (S14/N), the selection unit 54 reads a usual normalization constant (S16). When fade_count≧2 is satisfied in the Doppler frequency determination (S14/Y), the selection unit 54 reads a normalization constant for fading (S18). The min-sum processing unit 46 executes min-sum decoding processing (S20).

According to the embodiment of the present invention, one of a plurality of normalization constants that have been specified in advance is selected in accordance with a situation in which fading occurs, for the execution of a min-sum algorithm, and hence a normalization constant suitable for the communication path can be used. Further, because a normalization constant suitable for the communication path is used, deterioration of the decoding characteristic can be suppressed, even when an influence by fading is great. Furthermore, because normalization constants different from each other are respectively used for both the cases where fading with a high Doppler frequency occurs and where such fading does not occur, an influence by fading with a high Doppler frequency can be reduced. Furthermore, because an influence by fading with a high Doppler frequency is reduced, deterioration of the decoding characteristic can be suppressed.

Furthermore, because the number of times when a received amplitude variation occurs is only counted for the estimation of a Doppler frequency, the estimation can be easily executed. Furthermore, because the estimation of a Doppler frequency is easily executed, an amount of computation can be reduced. Furthermore, because one of a plurality of normalization constants that have been specified in advance is only selected in accordance with a Doppler frequency, for the execution of a min-sum algorithm, an amount of computation can be reduced. Furthermore, because a normalization constant having a smaller value is selected as a Doppler frequency in fading becomes higher, an influence possibly exerted on the update of an external value ratio can be reduced. Furthermore, because an amount of computation is reduced, the scale of a circuit can be made small. Furthermore, because an amount of computation, occurring when a normalization constant is derived, is reduced, the min-sum decoding processing can be executed by an LSI (CPU) having a low processing capability.

### Second Embodiment

Second Embodiment of the present invention relates to a reception apparatus for executing a min-sum algorithm, similarly in First Embodiment. In First Embodiment, it is estimated whether fading with a Doppler frequency higher than a threshold value occurs, and a normalization constant is selected and used in accordance with whether such fading occurs. In Second Embodiment, threshold values in multiple stages are used. The communication system 100 according to Second Embodiment is the same type as that in FIG. 1, and the decoding unit 28 is the same type as that in FIG. 3. Hereinafter, differences between them will be mainly described.

The estimation unit 48 monitors whether fading with a Doppler frequency higher than or equal to a first threshold value (hereinafter, referred to as a “high-speed fading state”) occurs and whether fading with a Doppler frequency lower than the first threshold value and higher than or equal to a second threshold value (hereinafter, referred to as a “low-speed fading state”) occurs. For example, the first threshold value is set to “4” and the second threshold value is set to “2”. Accordingly, the estimation unit 48 estimates a degree of a fading variation as the situation of the communication path.

The normalization constant storage unit 52 stores three normalization constants consisting of a first constant, a second constant, and a third constant. The first constant is equivalent to the aforementioned normal constant. The second constant is a normalization constant to be used in a low-speed fading state, and the third constant is one to be used in a high-speed fading state. Herein, the first constant is 0.7, the second constant is 0.62, and the third constant is 0.50. Therefore, the second constant is smaller than the first constant, and the third constant is smaller than the second constant.

When it is estimated by the estimation unit 48 that a high-speed fading state occurs, the selection unit 54 selects the third constant; and when it is estimated by the estimation unit 48 that a low-speed fading state occurs, the selection unit 54 selects the second constant. That is, the selection unit 54 selects a normalization constant having a smaller value, as a degree of a fading variation, estimated by the estimation unit 48, becomes quicker.

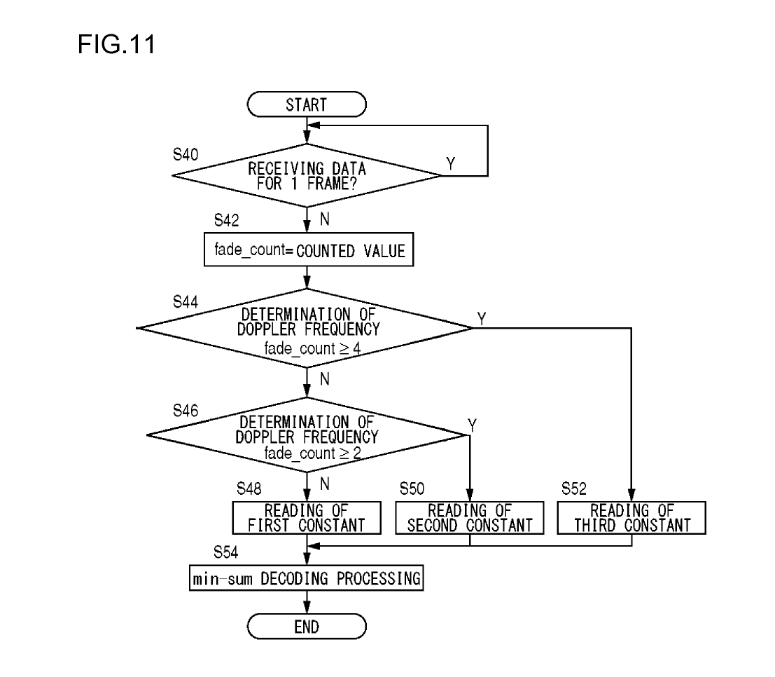

The operations of the communication system 100 having the aforementioned structure will be described. FIG. 11 is a flowchart indicating decoding procedures in the decoding unit 28 according to Second Embodiment of the present invention. When the frame data storage unit 40 is receiving data for one frame (S40/Y), the estimation unit waits. When the frame data storage unit 40 is not receiving data for one frame (S40/N), the estimation unit 48 inputs a counted value to the fade_count (S42). When fade_count≧4 is not satisfied in the Doppler frequency determination (S44/N), and when fade_count≧2 is not satisfied in the Doppler frequency determination (S46/N), the selection unit 54 reads the first constant (S48). When fade_counter≧2 is satisfied in the Doppler frequency determination (S46/Y), the selection unit 54 reads the second constant (S50). When fade_counter≧4 is satisfied in the Doppler frequency determination (S44/Y), the selection unit 54 reads the third constant (S52). The min-sum processing unit 46 executes the min-sum decoding processing (S54).

According to the embodiment of the present invention, a plurality of normalization constants are specified in accordance with the Doppler frequency of fading, and hence an influence by fading with one of various Doppler frequencies can be reduced. Further, because an influence by fading with one of various Doppler frequencies is reduced, deterioration of the decoding characteristic can be suppressed even when an assumed range of the Doppler frequency is wide.

### Third Embodiment

Third Embodiment of the present invention relates to a reception apparatus for executing a min-sum algorithm, similarly in the aforementioned Embodiments. In the aforementioned Embodiments, one of a plurality of normalization constants is selected and used in accordance with a Doppler frequency. On the other hand, in Third Embodiment, one of a plurality of normalization constants that have been stored in advance is selected and used in accordance with whether a received amplitude variation, occurring due to fading, occurs. The communication system 100 according to Third Embodiment is the same type as that in FIG. 1, and the decoding unit 28 is the same type as that in FIG. 3. Hereinafter, differences between them will be mainly described.

The estimation unit 48 receives the AGC control voltage from the non-illustrated demodulation unit 26. The estimation unit 48 monitors whether a received amplitude variation, occurring due to fading, etc, occurs. That is, the estimation unit 48 estimates a situation of the communication path based on the received data. The estimation unit 48 generates a received amplitude variation determination signal: that becomes a High level over a period during which a received amplitude variation occurs; and that becomes a Low level over a period during which a received amplitude variation does not occur, and outputs the signal to a non-illustrated fading occurrence timing storage unit.

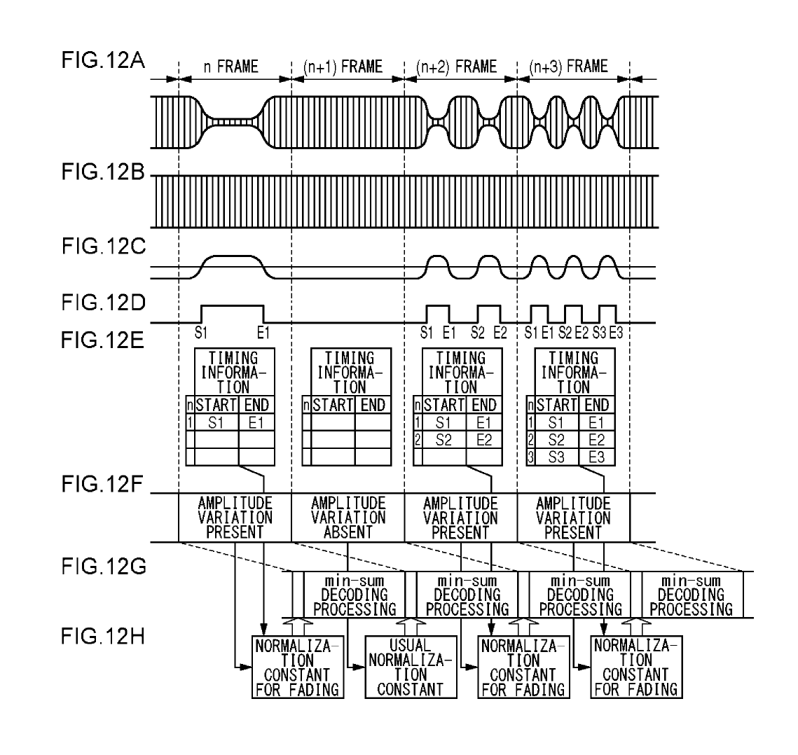

Herein, the processing in the estimation unit 48 will be described with reference to FIGS. 12A to 12H. FIGS. 12A to 12H are views explaining the outline of the operations of the decoding unit 28 according to Third Embodiment of the present invention. Because FIGS. 12A to 12D are the same as FIGS. 4A to 4D, description thereof will be omitted herein. In addition, FIG. 12D shows the received amplitude variation determination signals outputted from the estimation unit 48. When a received amplitude variation occurs, the received amplitude variation determination signal is set to the High level, and when a received amplitude variation does not occur, the received amplitude variation determination signal is set to the Low level. In addition, the start and the end of a period during which a signal of the High level occurs are indicated as “S1” and “E1”, respectively. FIGS. 12E to 12H will be described later. Reference is made to FIG. 3 again.

The non-illustrated fading occurrence timing storage unit receives the received amplitude variation determination signal from the estimation unit 48. The fading occurrence timing storage unit stores, based on the received amplitude variation determination signal, a start timing and an end timing of the period during which a received amplitude variation occurs as a table in units of frames. Herein, the start timing and the end timing are indicated as timings in a frame. In addition, there are sometimes the cases where a plurality of the start timings and the end timings are present in a frame. When a period during which a received amplitude variation occurs is present in a frame, the information, indicating that “an amplitude variation is present”, is stored in the fading occurrence timing storage unit, and when the period during which a received amplitude variation occurs is absent in a frame, the information, indicating that “an amplitude variation is absent”, is stored therein. FIG. 12E shows the tables stored in the fading occurrence timing storage unit. FIG. 12F shows both the information indicating that “an amplitude variation is present” and the information indicating that “an amplitude variation is absent”, each of which corresponds to each frame. FIGS. 12G and 12H will de described later. Reference is made to FIG. 3 again.

The selection unit 54 select one of a plurality of normalization constants stored in the normalization constant storage unit 52 in accordance with the table stored in the fading occurrence timing storage unit, to output the selected normalization constant to the min-sum processing unit 46. That is, the selection unit 54 selects, in accordance with the situation of the communication path estimated by the estimation unit 48, one of a plurality of normalization constants that have been specified in advance. Specifically, when a received amplitude variation is shown in a table in the fading occurrence timing storage unit, the selection unit 54 selects a constant for fading from the normalization constant storage unit 52. On the other hand, when a received amplitude variation is not shown in a table in the fading occurrence timing storage unit, the selection unit 54 selects a usual constant from the normalization constant storage unit 52. Accordingly, when a received amplitude variation is present while frame data is being received, a constant for fading is selected, and when a received amplitude variation is absent, a usual constant is selected.

The min-sum processing unit 46 receives the demodulated data from the frame data storage unit 40 and receives the normalization constant from the selection unit 54. The min-sum processing unit 46 uses the normalization constant to execute a min-sum algorithm on the demodulated data. In FIG. 12G, the min-sum decoding processing is executed for each frame. The normalization constants to be used in this min-sum decoding processing are shown in FIG. 12H. When a received amplitude variation, occurring due to fading, etc., is detected according to received amplitude variation determination results in units of frames, a constant for fading is selected, and when a received amplitude variation is not detected, a usual constant is selected.

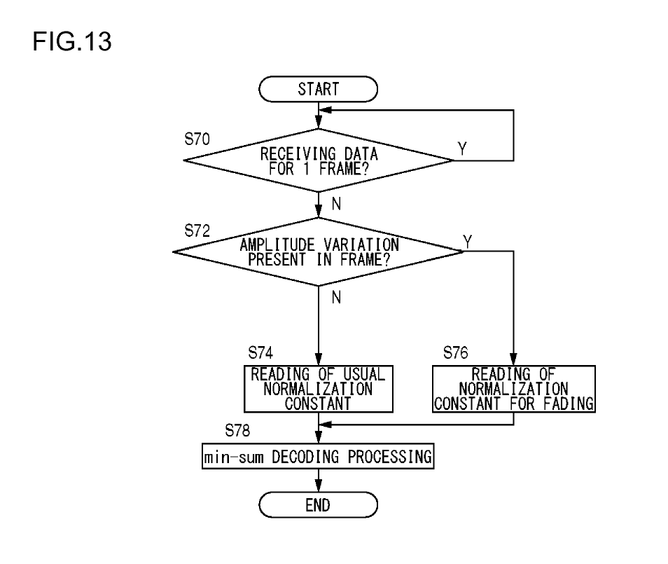

The operations of the communication system 100 having the aforementioned structure will be described. FIG. 13 is a flowchart indicating decoding procedures in the decoding unit 28 according to Third Embodiment of the present invention. When the frame data storage unit 40 is receiving data for one frame (S70/Y), the estimation unit 48 waits. When the frame data storage unit 40 is not receiving data for one frame (S70/N) and when the estimation unit 48 detects that an variation is absent in a frame (S72/N), the selection unit 54 reads a usual normalization constant (S74). When the estimation unit 48 detects that an amplitude variation is present in a frame (S72/Y), the selection unit 54 reads a normalization constant for fading (S76). The min-sum processing unit 46 executes min-sum decoding processing (S78).

According to the embodiment of the present invention, one of a plurality of normalization constants that have been specified in advance is selected in accordance with the presence/absence of a received amplitude variation, for the execution of a min-sum algorithm, and hence deterioration of the decoding characteristic can be suppressed. Further, because one of a plurality of normalization constants that have been specified in advance is only selected in accordance with the presence/absence of a received amplitude variation, an amount of computation can be reduced.

### Fourth Embodiment

Fourth Embodiment of the present invention relates to a reception apparatus for executing a min-sum algorithm, similarly in the aforementioned embodiments. In this case, one of a plurality of normalization constants that have been stored in advance is selected and used. In Third Embodiment, either of two normalization constants is selected in accordance with whether a received amplitude variation occurs. On the other hand, in Fourth Embodiment, when a received amplitude variation occurs, a normalization constant is further switched even in accordance with a ratio of a period, during which the received amplitude variation occurs, to a frame time length. The communication system 100 according to Fourth Embodiment is the same type as that in FIG. 1, and the decoding unit 28 is the same type as that in FIG. 3. Hereinafter, differences between them will be mainly described.

A non-illustrated fading occurrence timing storage unit derives a ratio of a period, during which a received amplitude variation occurs, to a frame time length. For example, in the case of the n frame in FIG. 12E, the ratio of a period, during which a received amplitude variation occurs, is derived from a difference between S1 and E1 of the received amplitude variation.

Ratio={variation end position (E1)−Variation start position (S1)}/one frame time length (4)

That is, the fading occurrence timing storage unit derives a period during which the situation of the communication path is bad.

The normalization constant storage unit 52 stores a plurality of normalization constants in advance. Herein, three normalization constants are stored, which are a usual constant, a constant for short-time fading, and a constant for long-time fading. Herein, the constant for short-time fading is a normalization constant to be used in the case where the ratio of a period, during which a received amplitude variation occurs, to a frame time length is small, for example, in the case where the ratio is smaller than ½. The constant for long-time fading is a normalization constant to be used in the case where the ratio is large, for example, in the case where the ratio is ½ or more.

The selection unit 54 selects, in accordance with a table stored in the fading occurrence timing storage unit, one of a plurality of normalization constants that have been stored in the normalization constant storage unit 52, to output the selected normalization constant to the min-sum processing unit 46. At the time, if a received amplitude variation is shown in a frame, the selection unit 54 selects the constant for short-time fading from the normalization constant storage unit 52, when the ratio is smaller than ½ in the frame. Even if a received amplitude variation is shown, the selection unit 54 selects the constant for long-time fading from the normalization constant storage unit 52, when the ratio is ½ or more in the frame. Herein, for example, the usual constant>the constant for short-time fading>the constant for long-time fading is satisfied. That is, as a period during which a received amplitude variation occurs becomes longer, a normalization constant having a smaller value is selected.

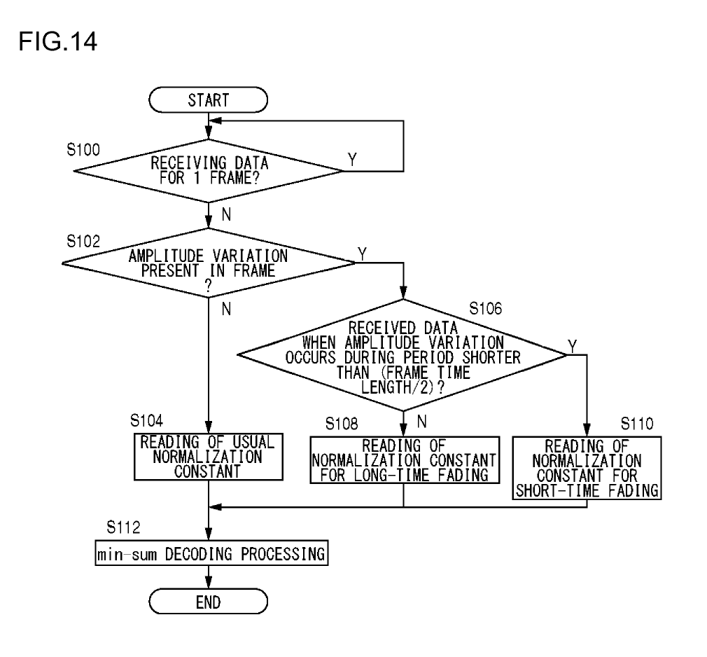

The operations of the communication system 100 having the aforementioned structure will be described. FIG. 14 is a flowchart indicating decoding procedures in the decoding unit 28 according to Fourth Embodiment of the present invention. When the frame data storage unit 40 is receiving data for one frame (S100/Y), the selection unit 54 waits. When the frame data storage unit 40 is not receiving data for one frame (S100/N), and when the estimation unit 48 detects that an amplitude variation is absent in a frame (S102/N), the selection unit 54 reads the usual normalization constant (S104).

When the estimation unit 48 detects that an amplitude variation is present in a frame (S102/Y), and when the period during which the amplitude variation occurs is not shorter than the half the frame time length (S106/N), the selection unit 54 reads the normalization constant for long-time fading (S108). When the period during which the amplitude variation occurs is shorter than the half the frame time length (S106/Y), the selection unit 54 reads the constant for short-time fading (S110). The min-sum processing unit 46 executes min-sum decoding processing (S112).

According to the embodiment of the present invention, one of the normalization constants is selected in accordance with a period during which a received amplitude variation occurs, and hence a normalization constant, suitable for a period during which the situation of the communication path is bad, can be used. Further, because one of the plurality of normalization constants is selected in accordance with a period during which a received amplitude variation occurs, the normalization constants can be set in detail. Furthermore, because the normalization constants are set in detail, a normalization constant, suitable for a situation in which fading occurs, can be used. Furthermore, because a normalization constant, suitable for a situation in which fading occurs, is used, deterioration of the decoding characteristic can be suppressed.

The present invention has been described above based on preferred embodiments. The embodiments are described for exemplary purposes only, and it can be readily understood by those skilled in the art that various modifications may be made by making various combinations of the aforementioned components or processes, which are also encompassed by the scope of the present invention.

It is assumed that the communication system 100 according to each of First Embodiment to Fourth Embodiment relates to a wireless communication system, and hence the transmission apparatus 10 and the reception apparatus 12 are included in a wireless communication apparatus. However, the communication system 100 is not limited thereto, but it may be assumed that the communication system 100 relates to a wired communications system. In that case, the transmission apparatus 10 and the reception apparatus 12 are included in a wired communication apparatus. According to the present variation, the invention can be applied to various apparatuses.

In First Embodiment to Fourth Embodiment of the present invention, two or three normalization constants are specified. However, the number of the normalization constants is not limited thereto, but 4 or more of normalization constants may be specified. In that case, threshold values, the number of which is set in accordance with the number of the normalization constants, are also specified. According to the present variation, normalization constants can be set in detail.

In First Embodiment to Fourth Embodiment of the present invention, the transmission apparatus 10 executes LDPC encoding. However, the transmission apparatus 10 is not limited thereto, but may execute, even other than LDPC, encoding in which a min-sum algorithm can be executed when being decoded. According th the present variation, the invention can be applied to various encoding.

What is claimed is:

1. A decoding apparatus comprising:
an input unit configured to input encoded data via a communication path;
an estimation unit configured to estimate a situation of the communication path based on the data inputted by the input unit;
a selection unit configured to select, in accordance with the situation of the communication path estimated by the estimation unit, one of a plurality of normalization constants that have been specified in advance and are to be used in updating an exterior value ratio based on a priori value ratio in check node processing according to a min-sum algorithm; and
a decoding unit configured to execute, on the data inputted by the input unit, the min-sum algorithm by using the normalization constant selected by the selection unit.

2. The decoding apparatus according to claim 1, wherein
the selection unit selects a normalization constant having a smaller value, as the situation of the communication path estimated by the estimation unit becomes worse.

3. The decoding apparatus according to claim 1, wherein
the estimation unit estimates a degree of a fading variation as the situation of the communication path, and wherein
the selection unit selects a normalization constant having a smaller value, as the degree of a fading variation estimated by the estimation unit becomes quicker.

4. The decoding apparatus according to claim 1, wherein
the estimation unit estimates, as the situation of the communication path, a period during which an amplitude variation occurs, and wherein
the selection unit selects a normalization constant having a smaller value, as the period during which an amplitude variation occurs, estimated by the estimation unit, becomes longer.

5. A decoding method comprising:
inputting encoded data via a communication path;
estimating, based on the inputted data, a situation of the communication path;
selecting, in accordance with the estimated situation of the communication path, one of a plurality of normalization constants that have been specified in advance and are to be used in updating an external value ratio based on a priori value ratio in check node processing according to a min-sum algorithm; and
executing, on the inputted data, the min-sum algorithm by using the selected normalization constant.

6. The decoding method according to claim 5, wherein
in the selection, a normalization constant having a smaller value is selected as the estimated situation of the communication path becomes worse.

7. The decoding method according to claim 5, wherein
in the estimation, a degree of a fading variation is estimated as the situation of the communication path, and wherein
in the selection, a normalization constant having a smaller value is selected as the estimated degree of a fading variation becomes quicker.

8. The decoding method according to claim 5, wherein
in the estimation, a period during which an amplitude variation occurs is estimated as the situation of the communication path, and wherein
in the selection, a normalization constant having a smaller value is selected as the estimated period during which an amplitude variation occurs becomes longer.
